(19) United States
(12) Patent Application Publication
(10) Pub. No.: US 2018/0141089 A1
(43) Pub. Date: May 24, 2018

(54) IMPROVED APPARATUS AND METHOD

(71) Applicant: Xeros Limited, Rotherham, South Yorkshire (GB)

(72) Inventors: Michael David SAWFORD, Rotherham, South Yorkshire (GB); Iain Alexander SCOTT, Rotherham, South Yorkshire (GB); Thomas John WALLACE, Rotherham, South Yorkshire (GB)

(73) Assignee: Xeros Limited, Rotherham, South Yorkshire (GB)

(21) Appl. No.: 15/578,306

(22) PCT Filed: May 31, 2016
(86) PCT No.: PCT/GB2016/051584

§ 371 Date: Nov. 30, 2017

(30) Foreign Application Priority Data
Jun. 1, 2015 (GB) 1509463.4

(51) Int. Cl. B08B 3/04; D06F 39/08; D06F 35/00; D06F 39/14

(52) U.S. Cl. CPC B08B 3/044; D06F 39/14; D06F 35/006; D06F 39/083

(57) ABSTRACT

An apparatus (10) for use in the treatment of at least one substrate with a multiplicity of solid particles comprising: a) a housing (20) in which a drum (40) is rotatably mounted; b) a door (60) moveable between an open position wherein the at least one substrate can be placed in the drum and a closed position wherein the apparatus is substantially sealed; c) a separator (100) mounted in the door, wherein the separator comprises a perforated portion; d) a flow pathway pipe (110) mounted on or in the housing, wherein the flow pathway pipe comprises an outlet (140); and e) pumping means (210) configured to pump treatment liquor and a multiplicity of solid particles from a first location through the flow pathway pipe and out of the outlet towards the separator; wherein the separator is arranged to direct the multiplicity of solid particles into the drum and wherein the separator is further arranged to direct a portion of the treatment liquor to a location other than the drum.

The present disclosure relates to an apparatus that employs a multiplicity of solid particles in the treatment of substrates. The present disclosure further relates to the operation of an apparatus for the treatment of substrates using solid particles.

Standard methods for domestic and industrial cleaning of textiles and fabrics involve aqueous cleaning. These methods generally involve aqueous submersion of fabrics followed by soil removal, aqueous soil suspension, and water rinsing.

However, it is recognised that there are advantages to having reduced water consumption. For example, reducing water consumption has the effect of reducing the amount of effluent water that needs to be treated or disposed of. Reducing the amount of water also lowers the energy requirements of the process, as less energy is needed to heat the water, and reduces the amount of detergent required to achieve a desired detergent concentration. On the other hand, it is known that better cleaning is achieved by having more water present in the drum of a washing machine. Therefore, there is a need to reduce the amount of water used in washing processes while still allowing efficient cleaning of the soiled substrate.

In the light of the challenges which are associated with aqueous washing processes, the present applicant has previously devised a new approach to the problem that allows the deficiencies demonstrated by the methods of the prior art to be mitigated or overcome. The method which is provided eliminates the requirement for the use of large volumes of water, but is still capable of providing an efficient means of cleaning and stain removal, whilst also yielding economic and environmental benefits.

Thus, in WO2007/128962 there is disclosed a method and formulation for cleaning a soiled substrate, the method comprising the treatment of the moistened substrate with a formulation comprising a multiplicity of polymeric particles, wherein the formulation is free of organic solvents. The substrate may be wetted so as to achieve a substrate to water ratio of from 1:0.1 to 1:5 w/w, and optionally, the formulation additionally comprises at least one cleaning material, which typically comprises a surfactant, which preferably has detergent properties. In the disclosed embodiments, the substrate comprises a textile fibre. The polymeric particles may, for example, comprise particles of polyamides, polyesters, polyalkenes, polyurethanes or their copolymers, a particular example being nylon beads.

The use of this cleaning method, however, presents a requirement for the nylon beads to be efficiently separated from the cleaned substrate at the conclusion of the cleaning operation. This issue was addressed in WO2010/094959, which provides cleaning apparatus requiring the use of two internal drums capable of independent rotation, and which finds application in both industrial and domestic cleaning processes.

With a view to providing a simpler, more economical means for addressing the problem of efficient separation of the cleaning beads from the substrate at the conclusion of the cleaning process, a further apparatus is disclosed in WO2011/064581. The apparatus of WO2011/064581, which finds application in both industrial and domestic cleaning processes, comprises a perforated drum and a removable outer drum skin which is adapted to prevent the ingress or egress of fluids and solid particulate matter from the interior of the drum. The cleaning method requires attachment of the outer skin to the drum during a first wash cycle, after which the skin is removed prior to operating a second wash cycle, following which the cleaned substrate is removed from the drum. The apparatus and method of WO2011/064581 is extremely effective in successfully cleaning substrates, but the requirement for the attachment and removal of the outer skin detracts from the overall efficiency of the process. By providing for continuous circulation of the cleaning beads during the cleaning process, it was possible to dispense with the requirement for an outer skin.

Thus, in WO2011/098815, there is provided an apparatus for use in the cleaning of soiled substrates, the apparatus comprising housing means having a first upper chamber with a rotatably mounted cylindrical cage mounted therein and a second lower chamber located beneath the cylindrical cage, and additionally comprising at least one recirculation means, access means, pumping means and a multiplicity of delivery means, wherein the rotatably mounted cylindrical cage comprises a drum having perforated side walls where up to 60% of the surface area of the side walls comprises perforations comprising holes having a diameter of no greater than 25.0 mm.

The apparatus of WO2011/098815 is used for the cleaning of soiled substrates by methods which comprise the treatment of the substrates with formulations comprising solid particulate cleaning material and wash water, the methods typically comprising the steps of:

(a) introducing solid particulate cleaning material and water into the lower chamber of the apparatus;

(b) agitating and heating the solid particulate cleaning material and water;

(c) loading at least one soiled substrate into the rotatably mounted cylindrical cage via the access means;

(d) closing the access means so as to provide a substantially sealed system;

(e) introducing the solid particulate cleaning material and water into the rotatably mounted cylindrical cage;

(f) operating the apparatus for a wash cycle, wherein the rotatably mounted cylindrical cage is caused to rotate and wherein fluids and solid particulate cleaning material are caused to fall through perforations in the rotatably mounted cylindrical cage into the lower chamber in a controlled manner;

(g) operating the pumping means so as to transfer fresh solid particulate cleaning material and recycle used solid particulate cleaning material to separating means;

(h) operating control means so as to add the fresh and recycled solid particulate cleaning material to the rotatably mounted cylindrical cage in a controlled manner; and

(i) continuing with steps (f), (g) and (h) as required to effect cleaning of the soiled substrate.

The apparatus of WO2011/098815 includes features to introduce solid particulate cleaning material into the rotatably mounted cylindrical cage and also comprises at least one recirculation means to facilitate recirculation of the solid particulate material for its re-use in cleaning operations. In addition, the apparatus of WO2011/098815 can include ducting comprising separating means for separating the solid particulate material from water and control means adapted to control entry of the solid particulate material into the cylindrical cage. In one disclosed embodiment, the separating means comprises a rigid filter material such as wire mesh located in a receptor vessel above the cylindrical cage, and the control means comprises a valve located in feeder means, preferably in the form of a feed tube attached to the receptor vessel, and connected to the cage.

Although the apparatus disclosed in WO2011/098815 provided considerable improvements for the cleaning of soiled substrates with formulations comprising solid particulate cleaning material and wash water, there remain problems in separating the solid particulate material from water prior to the use and re-use of the solid particulate material in the cleaning operation. In particular, separation of the solid particulate material from the apparatus in WO2011/098815 is carried out using a separation vessel located above the cylindrical cage. Placement of the separating device in this position was considered to be necessary to allow the solid particulate material, in the form of beads, to fall under gravity to the filter material before entering the cylindrical cage. In order to recirculate, the solid particulate material was pumped along a recirculation path that extends from the sump located in the lower chamber of the apparatus to the separating vessel above the cylindrical cage.

A long recirculation path for the solid particulate material detrimentally impacts the efficiency of the apparatus as more energy is expended for pumping and a larger pump may be required to transport the solid particulate material along the recirculation path. Furthermore, as beads are pumped in combination with water along the recirculation path, then a relatively longer recirculation path is associated with relatively greater water usage within the apparatus because of the relatively greater total volume of water required for recirculation. In addition, the inclusion of a separating vessel above the cylindrical cage adversely increases the size of the apparatus, considerations that are particularly important for domestic washing machines.

The apparatus of WO2015/049544 addressed some of the deficiencies of the apparatus and method disclosed in WO2011/098815. In the apparatus of WO2015/049544, the door for providing access to the rotatably mounted drum of the cleaning apparatus is a door comprising a flow pathway for wash liquor and a multiplicity of solid particles and a separator. The separator is arranged to direct the multiplicity of solid particles from the flow pathway into the drum and the separator is further arranged to direct a portion of the wash liquor from the flow pathway to a location other than into the drum. In this way, the size of the cleaning apparatus was reduced by providing the separator as part of the door.

It is an object of the present disclosure to provide an improved apparatus and method for the cleaning of soiled substrates with solid particulate material. In particular, it is an object of the present disclosure to provide an improved apparatus and method for separating solid particulate material and water prior to the introduction of the solid particulate material in the cleaning operation. Improved separation of solid particulate material and water results in drier beads being used in the cleaning operation. It is a further object to provide an improved apparatus and method for cleaning soiled substrates with solid particulate material, which exhibit improved cleaning performance and/or which reduce water and energy consumption thereby improving the efficiency and economy of the apparatus and method. The inventors have surprisingly found that drier beads are able to provide improved cleaning performance.

According to a first aspect of the present disclosure there is provided an apparatus for use in the treatment of at least one substrate with a multiplicity of solid particles comprising:
a) a housing in which a drum is rotatably mounted;
b) a door moveable between an open position wherein the at least one substrate can be placed in the drum and a closed position wherein the apparatus is substantially sealed;
c) a separator mounted in the door, wherein the separator comprises a perforated portion;
d) a flow pathway pipe mounted on or in the housing, wherein the flow pathway pipe comprises an outlet; and
e) pumping means configured to pump a treatment liquor and a multiplicity of solid particles from a first location through the flow pathway pipe and out of the outlet towards the separator;

wherein the separator is arranged to direct the multiplicity of solid particles into the drum and

wherein the separator is further arranged to direct a portion of the treatment liquor to a location other than the drum; and

wherein the flow pathway pipe is not attached to the door.

The apparatus of the first aspect (and also of the second aspect described hereinbelow) is particularly suitable as a cleaning apparatus. Thus, the apparatus is particularly suitable as a cleaning apparatus for use in the cleaning of at least one soiled substrate, and in this embodiment said treatment liquor is suitably referred to as a wash liquor. The apparatus is also suitable more generally as an apparatus for treating a substrate with a multiplicity of solid particles, particularly wherein the substrate is an animal substrate (including skins, hides, pelts, leather and fleeces), and wherein the term “treating” includes colouring and tanning and associated tanning processes (including cleaning, curing beamhouse treatments including soaking, liming, unhairing, scudding, fleshing, deliming, bating, pickling and fat-liquoring, enzyme treatment and dye-fixing), as described in more detail in the applicant's patent applications published as WO-2014/167358-A, WO-2014/167359-A and WO-2014/167360-A and the disclosure of those processes is incorporated herein by reference. A treating process further includes finishing, dyeing, softening or stonewashing processes, particularly wherein the substrate is a textile or garment. The apparatus of the first and second aspects and the associated method are described hereinbelow with reference to a cleaning apparatus for cleaning soiled substrate(s) wherein the treatment liquor is wash liquor, but it will be appreciated that the following disclosure, particularly of the apparatus and all features thereof, is also applicable to the more general use of the apparatus for treating a substrate with a multiplicity of solid particles.

As used throughout the description in relation to all the aspects disclosed herein, “wash liquor” is a liquid used in the cleaning apparatus. Preferably, the wash liquor is an aqueous medium. The aqueous medium may comprise or consist of water. The aqueous medium may be water combined with at least one cleaning agent, such as a detergent composition and/or any further additives as detailed below.

As used throughout the description in relation to all the aspects disclosed herein, the “flow pathway pipe” is a route from the first location to the vicinity of the separator. The flow pathway pipe comprises an outlet. The solid particles and the wash liquor leave the flow pathway pipe through the outlet. The flow pathway may be a duct.

The flow pathway pipe preferably comprises a main portion and a nozzle portion, in which case the outlet is comprised in the nozzle portion. The main portion of the flow pathway pipe extends from the pumping means adjacent or comprised in the first location to the nozzle portion, and the nozzle portion is the portion of the flow pathway pipe that directs the wash liquor and the solid particles towards the separator.

The shape of the outlet is defined by the ends of the walls of the flow pathway pipe or, where present, the ends of the walls of the nozzle portion. The shape of the outlet may be planar, i.e. the ends of the walls of the flow pathway pipe or, where present, the ends of the walls of the nozzle portion, define a plane. Said plane may be perpendicular to the direction of flow of the solid particles and wash liquor through the outlet, or said plane may be inclined (typically by an angle of no more than about 50°) to the perpendicular direction relative to the direction of flow of the solid particles and wash liquor through the outlet.

As used herein, the term “perimeter of the outlet” describes a continuous line which defines the shape of the outlet. The perimeter may be rectilinear or curvilinear or a combination of rectilinear and curvilinear. The perimeter may be two-dimensional or three-dimensional. Thus, where the shape of the outlet defines a plane, the perimeter is two dimensional. Where the shape of the outlet defines multiple planes, or is non-planar or comprises non-planar sections (for instance, curves), then the perimeter is three-dimensional.

In the first aspect, no portion of the flow pathway pipe is attached to the door. As such, when the door is moved between the closed and open positions, the flow pathway pipe does not move. The flow pathway pipe is not affected by the opening and closing of the door. By having the separator mounted in the door and the flow pathway pipe mounted in the housing, the act of moving the door between the open position and the closed position does not require there to be separable portions of the flow pathway pipe. Advantageously, this also overcomes the problems associated with having to provide adequate sealing and re-sealing between separable portions of the flow pathway pipe each time the door is opened and closed.

The outlet is oriented such that the solid particles and the wash liquor are directed towards the separator on leaving the flow pathway pipe, and preferably towards the perforated portion of the separator, preferably such that the initial contact of solid particles and wash liquor leaving the flow pathway pipe with the separator is with the perforated portion of the separator. Typically, the perimeter of the outlet is located no more than 30 mm from the perforated portion of the separator. Typically, the perimeter of the outlet is located no more than 12 mm, preferably no more than 10 mm, preferably no more than 8 mm, more preferably no more than 6 mm, preferably no more than 4 mm from the perforated portion of the separator. The minimum distance between the perimeter of the outlet and the perforated portion of the separator is dictated by the size of the solid particles being used, such that said minimum distance is greater than the largest dimension of the solid particles. Typically, the distance between the perimeter of the outlet and the perforated portion of the separator is no more than 24 mm, preferably no more than 6 mm, preferably no more than 4 mm larger than the largest dimension of the solid particles. Preferably, the distance between the perimeter of the outlet and the perforated portion of the separator is no more than 2 mm, preferably no more than 1 mm larger than the largest dimension of the solid particles. Generally, the perimeter of the outlet is positioned at least 2 mm, preferably at least 3 mm from the perforated portion of the separator. Reducing the distance between the perimeter of the outlet of the flow pathway pipe and the perforated portion of the separator improves the ability of the separator to separate the solid particles from the wash liquor.

Preferably, the perimeter of the outlet is substantially equidistant from the perforated portion of the separator. As such, the distance between each point on the perimeter of the outlet and the nearest point of the perforated portion of the separator is substantially the same. Preferably the distance between any point on the perimeter of the outlet and the nearest point of the perforated portion of the separator varies by no more than ±2 mm, preferably by no more than ±1 mm, more preferably by no more than ±0.5 mm from the distance between any other point on the perimeter of the outlet and its nearest point of the perforated portion of the separator.

Where the perimeter of the outlet is not equidistant from the perforated portion of the separator, the outlet is oriented such that at least a portion of the perimeter (preferably at least 50%, preferably at least 70%) is at least a minimum distance away from the separator, wherein said minimum distance is greater than the largest dimension of the solid particles.

Preferably, the cross-sectional area of the outlet is smaller than the cross-sectional area of the flow pathway pipe. By reducing the cross-sectional area of the outlet relative to the cross-sectional area of the flow pathway pipe, improved separation of the solid particles from the wash liquor is achieved.

As described in more detail below, it is preferred that the bore of the flow pathway pipe narrows as the flow pathway pipe approaches its outlet, and typically the narrowing of the bore of the flow pathway pipe occurs in the nozzle portion thereof, where present. Preferably, the bore of the flow pathway pipe narrows gradually in order to minimize turbulence in the flow of the wash liquor and solid particles being pumped through the flow pathway pipe. Where the flow pathway pipe comprises a nozzle portion and a main portion, the cross-sectional area of the main portion is preferably substantially constant along its length.

Without being bound by theory, it is believed that by having an arrangement where the cross-sectional area of the outlet is narrower than the cross-sectional area of the flow pathway pipe, the velocity of the solid particles and wash liquor leaving the outlet is increased. By increasing the velocity of the solid particles and wash liquor that impinge on the separator, improved separation of the solid particles from the wash liquor is achieved. Improved separation of the solid particles from the wash liquor results in drier solid particles being directed to the drum, which surprisingly allows for improved cleaning of the at least one soiled substrate. Improved separation of wash liquor from the solid particles allows the wash liquor to be returned to the first location more quickly than if it flowed through the substrate, reducing the amount of water required in the cleaning apparatus.

Typically, the cross-sectional area of the outlet is from about 10% to about 99% of the cross-sectional area of the flow pathway pipe. The cross-sectional area of the outlet may be from about 20% to about 95%, from about 30% to about 90%, from about 40% to about 80%, from about 50% to about 90%, from about 50% to about 70%, preferably from about 55% to about 60% of the cross-sectional area of the flow pathway pipe. Preferably, the cross-sectional area of the outlet may be from about 55% to about 65% of the cross-sectional area of the flow pathway pipe.

Where there is variation in cross-sectional area along the length of the flow pathway pipe, the % is calculated with respect to the largest cross-sectional area of the flow pathway pipe, and where the flow pathway pipe comprises a main portion and a nozzle portion, the % is calculated with respect to the largest cross-sectional area of the main portion of the flow pathway pipe.

At its largest point, the cross-sectional area of the flow pathway pipe may be from 1000 mm² to 5000 mm², preferably from 2000 mm² to 4000 mm², more preferably from 2500 mm² to 3500 mm². In a particular arrangement, the cross-sectional area of the flow pathway pipe is about 3170 mm².

The cross-sectional area of the outlet may be from 1000 mm² to 3000 mm², preferably from 1000 mm² to 2500 mm², more preferably from 1500 mm² to 2000 mm². In a particular arrangement, the cross-sectional area of the outlet is about 2030 mm². In an alternative particular arrangement, the cross-sectional area of the outlet is about 1870 mm². In another alternative particular arrangement, the cross-sectional area of the outlet is about 1710 mm².

Preferably, the velocity of the wash liquor and the solid particles at the outlet is about 150 cm/s or more, preferably from about 150 to about 400 cm/s, preferably from about 200 cm/s to about 350 cm/s, preferably from about 200 cm/s to about 300 cm/s, preferably from about 250 cm/s to about 275 cm/s. Having a relatively high velocity of the wash liquor and solid particles at the outlet leads to improved separation of the solid particles from the wash liquor. Improved separation of the solid particles from the wash liquor results in drier solid particles being directed to the drum, which surprisingly allows for improved cleaning of the at least one soiled substrate.

Preferably, the outlet has an elongate shape. The elongate shape has a length, L, and a width, W, and the ratio L:W of the elongate shape is typically greater than 2:1, preferably greater than 3:1, more preferably greater than 5:1,and preferably no more than about 20:1, more preferably no more than about 15:1, more preferably no more than about 10:1.

An elongate shaped outlet allows the wash liquor and solid particles to have maximum coverage on the perforated portion of the separator. In particular, where the perforated portion of the separator is curved, having an elongate shape aligned along a direction of the perforated portion that is orthogonal to the direction of the curve leads to maximum coverage of the wash liquor and solid particles on the perforated portion. Maximising the coverage allows the wash liquor and solid particles to pass over more apertures in the perforated portion, thus allowing more opportunities for the wash liquor to pass through the separator.

The elongate shape may be a lozenge, a rectangle, a shape that is essentially rectangular but has rounded corners, or an obround. Preferably, the elongate shape is rectangular. Alternatively, the shape is preferably an obround. An elongate shaped outlet allows the wash liquor and multiplicity of solid particles to have maximum coverage on the perforated portion of the separator.

When the elongate shape is a lozenge, length L is the distance between one pair of opposite vertices and width W is the distance between the other pair of opposite vertices.

Preferably, the flow pathway pipe has a substantially circular cross-section, and where the flow pathway pipe comprises a main portion and a nozzle portion, it is preferred that the main portion has a substantially circular cross-section. As such, when the outlet has an elongate shape, typically the outlet shape is different to the cross-sectional shape of the flow pathway pipe.

Preferably, the outlet is aligned so that length L is at an angle of about 20° or less, preferably about 10° or less, preferably about 5° or less, more preferably about 1° or less away from horizontal. Most preferably, the outlet is aligned so that length L is horizontal.

When the perforated portion is curved, preferably, the outlet is aligned so that length L is parallel to a direction of the perforated portion that is not curved and width W is aligned with a direction of the perforated portion that is curved. Having the elongate outlet essentially parallel to the perforated portion of the separator improves the separation of solid particles from the wash liquor.

In the first aspect, the separator is mounted in the door. This arrangement advantageously provides easy access to the separator, allowing the separator or the perforated portion thereof to be more easily cleaned. Advantageously, the separator or just the perforated portion of the separator may be removable. Thus, the improved apparatus of the present invention provides a separator and a perforated portion thereof which may be cleaned and maintained more readily and may be easily replaced if damaged. Furthermore, having the separator located in the door provides for a short path length for the wash liquor to return to the first location, which reduces the amount of water required in the cleaning apparatus. In addition, by locating the separator in the door, the return of wash liquor to the first location is faster.

According to a second aspect of the present disclosure there is provided an apparatus for use in the treatment of at least one substrate with a multiplicity of solid particles comprising:
a) a housing in which a drum is rotatably mounted;
b) a door moveable between an open position wherein the at least one substrate can be placed in the drum and a closed position wherein the apparatus is substantially sealed;
c) a separator, wherein the separator comprises a perforated portion;
d) a flow pathway pipe mounted on or in the housing, wherein the flow pathway pipe comprises an outlet; and
e) pumping means configured to pump a treatment liquor and a multiplicity of solid particles from a first location through a flow pathway pipe and out of the outlet towards the separator;
wherein the separator is arranged to direct the multiplicity of solid particles into the drum and wherein the separator is further arranged to direct a portion of the treatment liquor to a location other than the drum; and
wherein at least one of the following conditions is fulfilled:
   (i) the cross-sectional area of the outlet is smaller than the cross-sectional area of the flow pathway pipe;
   (ii) the outlet has an elongate shape;
   (iii) the perimeter of the outlet is located no more than 30 mm, preferably no more than 12 mm from the perforated portion of the separator;
   (iv) the perimeter of the outlet is essentially equidistant from the perforated portion of the separator; and
   (v) the velocity of the treatment liquor and the solid particles at the outlet is from about 150 cm/s or more.

The cleaning apparatus may fulfill conditions (i) and (ii). The cleaning apparatus may fulfill conditions (i) and (iii). The cleaning apparatus may fulfill conditions (i) and (iv). The cleaning apparatus may fulfill conditions (i) and (v). The cleaning apparatus may fulfill conditions (ii) and (iii). The cleaning apparatus may fulfill conditions (ii) and (iv). The cleaning apparatus may fulfill conditions (ii) and (v). The cleaning apparatus may fulfill conditions (iii) and (iv). The cleaning apparatus may fulfill conditions (iii) and (v). The cleaning apparatus may fulfill conditions (iv) and (v). The cleaning apparatus may fulfill conditions (i) and (ii) and (iii). The cleaning apparatus may fulfill conditions (i) and (ii) and (iv). The cleaning apparatus may fulfill conditions (i) and (ii) and (v). The cleaning apparatus may fulfill conditions (ii) and (iii) and (iv). The cleaning apparatus may fulfill conditions (ii) and (iii) and (v). The cleaning apparatus may fulfill conditions (iii) and (iv) and (v). The cleaning apparatus may fulfill conditions (i) and (ii) and (iii) and (iv). The cleaning apparatus may fulfill conditions (i) and (ii) and (iii) and (v). The cleaning apparatus may fulfill conditions (i) and (ii) and (iv) and (v). The cleaning apparatus may fulfill conditions (i) and (iii) and (iv) and (v). The cleaning apparatus may fulfill conditions (ii) and (iii) and (iv) and (v). Preferably, the cleaning apparatus fulfills all of conditions (i) to (iv).

The description hereinabove of the dimensions, shape, cross-sectional area, velocity, orientation and alignment of the outlet, and the dimensions, shape and cross-sectional area of the flow pathway pipe of the first aspect apply equally to the second aspect, and also to the other aspects described herein.

In the second aspect, it is preferred that no portion of the flow pathway pipe is mounted in the door, so that the act of moving the door between the open position and the closed position does not require separable and resealable portions of the flow pathway pipe. However, in an alternative arrangement, a part of the flow pathway pipe may be mounted in the door. In such an arrangement, when the door is in the open position, there are created two separate sections of the flow pathway pipe and in this arrangement the cleaning apparatus suitably comprises a seal adapted to provide a seal between the two separate sections of the flow pathway pipe when the door is in the closed position.

In the second aspect, the separator may be mounted in the door, as described hereinabove for the first aspect.

Alternatively, in the second aspect, the separator may be mounted in a location other than the door. For example, the separator may be located at the top of the housing, for instance alongside or above the drum. The separator may be located inside the housing. Alternatively, part of or the entire separator may be located external to the housing. When the separator is in a location other than in the door, the cleaning apparatus is suitably arranged so that the separator is able to direct the solid particles towards the drum via a pipe or duct. The apparatus may be arranged such that the solid particles may move from the separator towards the drum under gravity.

The separator may be retro-fitted to an existing apparatus.

In a third aspect of the present disclosure there is provided a method of treating at least one substrate comprising the treatment of the substrate with a multiplicity of solid particles using any of the apparatus defined herein.

Preferably, the method comprises the steps of:
(a) loading the at least one substrate into the drum and closing the door;
(b) introducing treatment liquor to moisten the substrate;
(c) rotating the drum;
(d) operating pumping means to pump treatment liquor and the multiplicity of solid particles from the first location through the flow pathway pipe towards the separator and introducing the multiplicity of solid particles into the drum via the separator.

The method preferably further comprises the step of (e) operating the apparatus for a treatment cycle wherein the treatment liquor and the multiplicity of solid particles are transferred from the drum into a lower portion of the housing as the drum rotates.

The method preferably further comprises the steps of (f) operating the pumping means so as to pump additional treatment liquor and solid particles from the first location to the separator and to recirculate the multiplicity of solid particles used in step (d) for re-use in the treatment operation; and (g) continuing with steps (c), (d), (e) and (f) as required to effect treatment of the at least one substrate.

The following features apply to each of the aspects of the disclosure described herein.

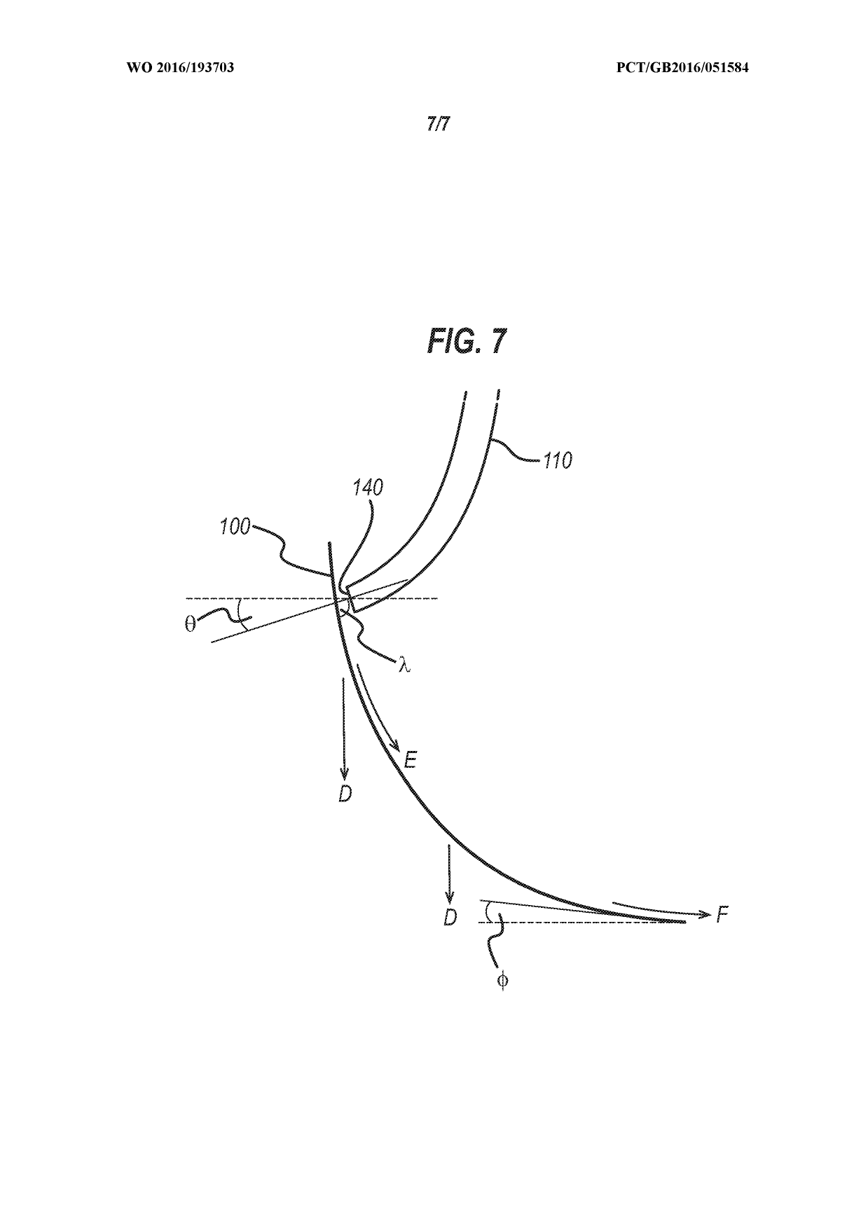

Preferably, the outlet is configured such that the path of the wash liquor and multiplicity of solid particles leaving the outlet defines an angle of incidence, angle λ as shown on FIG. 7, on the surface of the separator (and preferably on the perforated portion of the separator, as described hereinabove) of from about 60° to about 120°, preferably from about 65° to about 115°, preferably from about 70° to about 110°, preferably from about 75° to about 105°, preferably from about 80° to about 100°, more preferably from about 85° to about 95°. Preferably, the outlet is configured such that the path of the wash liquor and multiplicity of solid particles leaving the outlet defines an angle of incidence, angle λ as shown on FIG. 7, on the surface of the separator (and preferably on the perforated portion of the separator, as described hereinabove) of from about 60° to about 150°, preferably of from about 70° to about 150°, preferably from about 80° to about 140°, preferably from about 90° to about 130°. Most preferably, the wash liquor and multiplicity of solid particles are directed at an angle of incidence perpendicular or substantially perpendicular to the surface of the perforated portion of the separator on which it impinges. Having an angle of incidence that is perpendicular or substantially perpendicular improves the separation of solid particles from the wash liquor. As used herein, the term “substantially perpendicular” means ±5° to the perpendicular.

The perforated portion comprises a plurality of apertures. The perforated portion may be a web or mesh. Alternatively, the perforated portion may be a substrate having a plurality of apertures formed therein, i.e. wherein the apertures are created in an existing substrate (referred to herein as post-formed apertures). The apertures of the web or mesh and the apertures formed in a substrate are sized so as to permit the passage of wash liquor whilst preventing the passage of the multiplicity of solid particles. The apertures of the perforated portion may be any suitable shape, such as slots, circles or hexagons. Preferably the perforated portion has hexagonally shaped apertures.

The perforated portion may comprise a metal, an alloy, a polymer, a polymeric composite (such as a glass fibre reinforced polymer) or a ceramic. Preferably, the perforated portion comprises metal, more preferably stainless steel.

The perforated portion may be woven (such as a mesh formed from an interlaced network of wire or thread) or a substrate or plate with apertures formed therein (i.e. non-woven). Preferably the perforated portion is a metal plate with apertures formed therein. Having a metal plate with apertures formed therein generally reduces trapping of material compared with woven or mesh structures and allows for easier cleaning. Metal plates with apertures formed therein also suffer less from deformation and therefore require replacing less frequently.

In particular, the use of a metal plate having hexagonal apertures formed therein as the perforated portion leads to high levels of solid particle separation and, thus, drier beads returning to the drum. Furthermore, the use of a metal plate having hexagonal apertures formed therein is advantageous as it is durable and better able to withstand cleaning, in particular lint removal, without distorting aperture size or shape. A further advantage is that it is possible to form a separator entirely from the metal plate having hexagonal apertures without needing to include a support structure to maintain the shape of the separator. This is particularly advantageous when a curved separator is used in the cleaning apparatus.

The size of the apertures in the perforated portion of the separator depends on the size of the particles being used in the cleaning apparatus, such that the size of the apertures is smaller than the smallest dimension of the solid particles. Examples of suitable sizes for the apertures in the perforated portion include apertures having a length dimension in the region of from about 20 mm to about 40 mm and a width dimension in the region of from about 1.5 mm to about 3 mm. The perforated portion may have holes or apertures having a maximum dimension of from about 0.5 mm to about 4 mm, from about 1 mm to about 3 mm, from about 1.5 mm to about 2 mm, or from 0.5 mm to about 1 mm.

The total open area of the perforated portion of the separator (wherein the total open area is the total surface area of the apertures as a percentage of the total surface area of the perforated portion) is typically at least about 40%, at least about 45%, at least about 50%, at least about 55%, preferably at least about 60%. The total open area of the perforated portion of the separator is no more than about 99%, no more than about 90%, no more than about 80%, no more than about 75%, no more than about 70%, no more than about 65%. Preferably, the total open area is from about 45% to about 70%, preferably from about 60% to about 65%.

Hexagonal apertures (measured across opposite sides) are typically about 2 mm to about 3 mm in width, preferably about 2.5 mm to about 3 mm. Particularly preferred hexagonal apertures have a width of about 2.85 mm.

An examples of a suitable material that can be used as the perforated portion of the separator includes those with about 12 holes per inch with 54.1% open area or about 18 holes per inch with 53.7% open area.

A further example of a suitable material that can be used as the perforated portion of the separator is a stainless steel woven wire mesh having wire diameter of about 0.914 mm, aperture size of about 3.3 mm and open area of about 61.5%.

An example of a particularly preferred material that can be used as the perforated portion of the separator is a metal plate having hexagonal apertures of about 2.85 mm, a spacing of about 0.7 mm between apertures, an open area of about 64% and a material thickness of about 1.5 mm.

Advantageously, the perforated portion of the separator may also function as a lint filter. The presence of the perforated portion of the separator can obviate the need to have a separate lint filter in the cleaning apparatus. The arrangement of the separator in the door of the cleaning apparatus means that the separator may be accessed easily and the lint may be readily removed.

Where larger aperture sizes are selected, the ability to capture lint on the perforated portion of the separator generally reduces. Preferably, the apertures of the separator are small enough to capture lint and/or other unwanted fine particulate matter entrained in the wash liquor.

The perforated portion of the separator may be planar. Preferably, the perforated portion of the separator is curved. Having a curved perforated portion improves the separation of solid particles from the wash liquor. Having a curved perforated portion also aids transit of the solid particles across the separator and helps to prevent the solid particles from congregating or building up on the perforated portion of the separator, which otherwise might prevent wash liquor from being able to pass through the perforated portion. The perforated portion of the separator may comprise, for example, a circular curve, an ellipsoidal curve, a parabolic curve, a catenary curve, a curve where y=xⁿ and n>1, a trumpet-shaped curve, a daffodil-shaped curve or a J-shaped curve. Preferably, the perforated portion of the separator has a shape that assists the re-direction of the multiplicity of solid particles into the drum. Thus, the multiplicity of solid particles that are directed onto the separator follow a path that substantially corresponds to the curvature of the perforated portion of the separator.

Preferably, when the perforated portion is curved, it is curved only in one direction. Preferably, the perforated portion of the separator may comprise a curve having a radius of curvature of from about 100 mm to about 300 mm, more preferably from about 100 mm to about 200 mm. An example of a suitable separator has a perforated portion comprising a curve having a radius of curvature of about 160 mm. Preferably, the apparatus is arranged such that the outlet of the flow pathway pipe directs the wash liquor and the multiplicity of solid particles towards the concave surface of the curved perforated portion of the separator. In this arrangement, wash liquor passes through the perforated portion without substantially changing direction whereas the multiplicity of solid particles are caused to change direction as they follow the curvature of the separator towards the drum. This arrangement improves separation of wash liquor and solid particles.

The perforated portion of the separator is typically from about 5 cm to about 50 cm wide. The perforated portion of the separator is typically from about 10 cm to about 30 cm wide, preferably from about 15 cm to about 25 cm wide, more preferably from about 20 to about 25 cm wide. The length of the perforated portion of the separator, which is in the direction along which the wash liquor and solid particles travel after they strike the separator, is typically from about 10 cm to about 40 cm, preferably from about 15 cm to about 35 cm. When the separator is curved, it is preferably about 15 cm to about 25 cm wide and from about 15 cm to about 35 cm long.

Typically, the separator directs at least 1%, preferably at least 10%, preferably at least 25%, preferably at least 40%, preferably at least 50%, preferably at least 70%, preferably at least 90%, preferably at least 95%, preferably at least 99% by mass of wash liquor, relative to the total mass of wash liquor leaving the outlet, so that the wash liquor does not enter the drum with the solid particles.

The entry of a restricted amount of wash liquor into said drum can advantageously facilitate moistening of the soiled substrates for the cleaning operation. Therefore, the separator may be arranged to direct no greater than 99% by mass of wash liquor to a location so as to not enter the drum with the solid particulate material. Thus, up to 1% by mass of wash liquor may be permitted to enter the drum. Alternatively, the separator may be arranged to direct no greater than 90% by mass of wash liquor to a location so as to not enter the drum with the solid particles. Thus, up to 10% by mass of wash liquor may be permitted to enter the drum.

Preferably, the door comprises a transparent material. Preferably, the transparent material is arranged such that at least the perforated portion of the separator is visible from outside the cleaning apparatus. In this way, a user of the cleaning apparatus is readily able to observe whether maintenance, cleaning or replacement of the separator is required.

The door may be arranged such that it is substantially parallel to the front of the housing of the apparatus. Alternatively, the door may be arranged such that it is not parallel to the front of the housing of the apparatus. For example, an upper portion of the door may project out from the front of the housing further than a lower portion of the door. Having a door shaped in this way allows, for example, adequate space to locate a separator in the upper portion of the door in close proximity to the drum. The cleaning apparatus may have a collar or hood that projects out from the front face of the housing around part or all of the opening of the housing through which the drum is accessible. Typically, the door and the collar or hood are shaped so that when the door is closed, the door and the collar or hood cooperate to create a seal. There may be sealing means positioned between the door and the collar or hood.

The door suitably comprises a drain channel through which wash liquor that has passed through the separator may travel between an inner portion and an outer portion of the door and exit the door to a location other than the drum. Preferably, the location to which the separated wash liquor is directed is the first location. This arrangement provides a short path length through which the wash liquor passes in order to return to the first location. Having a short path length through which the wash liquor returns to the first location means that less water is needed to operate the cleaning apparatus, and hence a reduction in water consumption. A smaller water requirement is beneficial particularly in locations where there are water shortages. Furthermore, having a smaller water requirement means that less energy is needed to heat the water in the apparatus to the required temperature.

The apparatus suitably comprises a sump located in the housing. The first location referred to herein is preferably the sump.

The sump may comprise a first end proximate to the door and a second end distal to the door. The sump may comprise a sloping floor arranged to direct the solid particles to the second end. In this arrangement, the pumping means is preferably located proximate to the second end. Alternatively, the sump may comprise a sloping floor arranged to direct the solid particles to the first end. In this arrangement, the pumping means is preferably located proximate to the first end. Alternatively, the floor of the sump may be essentially horizontal. In this arrangement, the solid particles and water in the sump may be pumped from any point along the sump. In particular, a particularly preferred arrangement has the pump located to one side of the sump so that the flow pathway pipe may be positioned to pass up one side of the drum towards the separator.

The sump may comprise a bottom portion proximate a lower portion of the housing and a top portion proximate the drum. Preferably, the sump is shaped such that along the direction from the first end to the second end, the bottom portion is narrower than the top portion. Typically, the sump has a U-shaped cross section. Preferably, the bottom portion of the sump is from about 5 to about 25 cm wide, preferably from about 10 to about 20 cm wide, preferably from about 14 to 15 cm wide. If the width at the bottom portion of the sump is too small, the solid particles may bridge across the top of the sump and may not be picked up by wash liquor being pumped through the sump.

Preferably, the sump walls between the bottom portion and the top portion are inclined at an angle from horizontal of from about 24° to about 80°, preferably from about 24° to about 50°, more preferably from about 24° to about 35°, more preferably from about 24° to about 30°, more preferably from about 25° to about 30°, more preferably from about 27° to about 30°. As the angle of the walls increases away from horizontal, more solid particles falling into the sump are able to slide down the walls and occupy the region at the bottom of the sump. Having the solid particles reaching the region at the bottom of the pump means that more particles can be picked up within the wash liquor that is pumped through the sump. This helps to minimize the amount of water required in the cleaning apparatus. On the other hand, the bigger the angle is away from horizontal, the bigger the sump area needs to be, which means that the overall machine size needs to be larger, which may be undesirable. The ranges from about 25° to about 30° and from about 27° to about 30° are particularly preferred because these provide a balance between maximizing the volume in the sump and the return of the solid particles without overly increasing the overall dimensions of the cleaning apparatus.

The housing suitably comprises a tub and the drum is suitably mounted within the tub. The sump may be formed from part of the tub.

The solid particles are preferably located in the sump prior to the start of the method of cleaning using the cleaning apparatus. In operation, water may be added to the solid particles in the sump. When a threshold or desired volume of water is present in the sump, the water and solid particles may be pumped towards the separator. During the wash cycle, water and/or one or more cleaning agents can be added from delivery means into the drum and ultimately any wash liquor can be transferred to the sump, for example, by moving through perforations in the walls of the drum. In this way, during the course of the wash cycle, the contents of the sump may comprise wash liquor and a multiplicity of solid particles.

The pumping means is suitably located in a lower portion of the housing. The pumping means may be located in or be connected to the first location, such as a sump. The sump may comprise pumping means. The pumping means is preferably located at an end of the sump nearest the door, which suitably provides for a short pumping path for the introduction of the solid particles into the drum.

The pumping means draws the wash liquor and solid particles from the first location, such as the sump along the flow pathway pipe. The flow pathway pipe may extend from the pump through the rear part of the housing or through the housing to one side of the drum and then over and across at least part of the upper portion of the drum towards the separator. When the separator is mounted in the door, the flow pathway pipe is configured so that it ends in the vicinity of the door.

Typically, an electronic controller is used to control the pumping means. The electronic controller comprises a processor and a memory comprising logical instructions that when executed by the processor cause the pumping means to pump the wash liquor and the multiplicity of solid particles.

The memory may also comprise logical instructions that when executed by the processor cause the drum to rotate such that the at least one soiled substrate describes an annular path whereby a central portion of the drum is not occupied by any soiled substrate. Preferably, the drum is caused to rotate at a G force of at least 1, and preferably the G force is from about 1 to about 10. The drum may be caused to rotate in this way prior to the processor causing the pumping means to pump the wash liquor and the multiplicity of solid particles.

The cleaning apparatus is adapted to recirculate the wash liquor and the multiplicity of solid particles. Recirculation of the solid particles enables their re-use in the cleaning operation. The recirculation path suitably comprises the flow pathway pipe.

Preferably, the multiplicity of solid particles directed by the separator into the drum has a wetness of about 20 wt % or less, preferably about 18 wt % or less, more preferably about 15 wt % or less, most preferably about 10 wt % or less, and it will be appreciated that the wetness is the wetness of the particles on entry into the drum. As used herein, the term “wetness” is defined as the amount of water present in a multiplicity of solid particles relative to the weight of the solid particles. The wetness of the multiplicity of solid particles directed by the separator into the drum (also known as “bead wetness”) is measured, for example, by capturing the solid particles that are directed to the drum by the separator into a bag which is retained within a tub located in the drum. The solid particles and the bag are then lifted from the tub and suspended above it until water has ceased to drip from the bag. An example of a suitable bag is a flat drawstring mesh bag (supplied by Applied Thoughts & Applied Business Techniques, Ltd) made from 100% polyester, having a height of 86 cm and a width of 58 cm. The mesh bag has apertures of about 1 mm with intermediate smaller holes of 0.5 mm. The mass of the water separated from the particles is measured and the mass of the solid particles from which the water has been separated is also measured. The bead wetness is calculated, as a percentage, as the mass of the water separated from the solid particles divided by the mass of the solid particles from which the water has been separated.

Preferably, the apparatus is configured such that the separator receives a substantially downward flow of the wash liquor and the multiplicity of solid particles from the flow pathway pipe. The term “substantially downward flow” as used herein in this context means that the flow of wash liquor and solid particles in the flow pathway pipe towards the outlet thereof, for instance towards the nozzle portion (where present) of the flow pathway pipe, is substantially downwards Alternatively, the apparatus may be configured such that the separator receives the wash liquor and the multiplicity of solid particles from a different direction, such as from an upward flow or horizontal flow from the flow pathway pipe.

Typically, the drum is mounted substantially horizontally in the housing. The drum may comprise a rotatably mounted cylindrical cage comprising perforated side walls wherein the perforations comprise holes having a diameter of from about 1 mm to about 5 mm. Preferably, the perforations comprise holes having a diameter of from about 1 mm to about 3 mm. The perforations in the drum are preferably larger than the largest dimension of the solid particles, to allow passage of the solid particles through said perforations. Alternatively or in addition, the drum may comprise one or more lifters (described hereinbelow), wherein the one or more lifters may comprise one or more apertures providing an alternative route for transfer of the solid particles out of the drum. The one or more apertures are preferably larger than the largest dimension of the solid particles. Typically, the one or more apertures may have a diameter of from about 1 mm to about 20 mm, preferably from about 1 mm to about 15 mm. Typically, the one or more apertures may have a diameter of from about 1 mm to about 10 mm, preferably from about 1 mm to about 8 mm, preferably from about 1 mm to about 6 mm. The one or more lifters may comprise one or more apertures having a smallest dimension, wherein the smallest dimension is from about 1 mm to about 20 mm, preferably from about 1 mm to about 15 mm, preferably from about 1 mm to about 10 mm, preferably from about 1 mm to about 8 mm, preferably from about 1 mm to about 6 mm. Particularly suitably, the apparatus comprises lifters when the apparatus is being used with solid particles having relatively large dimensions.

The at least one soiled substrate may comprise a textile material or fabric material, such as garments, linens, napery, towels or the like. The cleaning apparatus is particularly successful in achieving efficient cleaning of textile fibres which may, for example, comprise either natural fibres, such as cotton, wool, silk or man-made and synthetic textile fibres, for example nylon 6,6, polyester, cellulose acetate, or fibre blends thereof.

The multiplicity of solid particles described herein is distinguished from a conventional washing powder, that is, a laundry detergent in powder form. Washing powder is generally soluble in the wash water and is included primarily for its detergent qualities. The washing powder is disposed of during the wash cycle and is sent to drain in grey water along with removed soil. In contrast, a significant function of the multiplicity of solid particles referred to herein is a mechanical action on the substrate which enhances cleaning of the substrate. The multiplicity of solid particles are preferably re-used one or more times for cleaning of at least one soiled substrate in, with or by the cleaning apparatus. The multiplicity of solid particles may be re-used in subsequent cleaning cycles for subsequent washload(s) of soiled substrate(s). The multiplicity of solid particles may be in the form of beads.

The multiplicity of solid particles may comprise or may consist of a multiplicity of polymeric particles. The multiplicity of solid particles may comprise or may consist of a multiplicity of non-polymeric particles. The multiplicity of solid particles may comprise or may consist of a mixture of polymeric solid particles and non-polymeric solid particles.

The polymeric particles may comprise polyalkenes such as polyethylene and polypropylene, polyamides, polyesters, polysiloxanes or polyurethanes. Furthermore, said polymers can be linear, branched or crosslinked. The polymeric particles may comprise polyamide or polyester particles, particularly particles of nylon, polyethylene terephthalate or polybutylene terephthalate, typically in the form of beads. Polyamides and polyesters are found to be particularly effective for aqueous stain/soil removal, whilst polyalkenes are especially useful for the removal of oil-based stains.

Various nylon homo- or co-polymers may be used including, but not limited to, Nylon 6 and Nylon 6,6. The nylon may comprise Nylon 6,6 copolymer having a molecular weight in the region of from about 5000 to about 30000 Daltons, such as from about 10000 to about 20000 Daltons, or such as from about 15000 to about 16000 Daltons. Useful polyesters may have a molecular weight corresponding to an intrinsic viscosity measurement in the range of from about 0.3 to about 1.5 dl/g, as measured by a solution technique such as ASTM D-4603.

The polymeric particles can comprise foamed polymers or unfoamed polymers. The polymeric particles may comprise wood.

Optionally, copolymers of the above polymeric materials may be employed. Specifically, the properties of the polymeric materials can be tailored to specific requirements by the inclusion of monomeric units which confer particular properties on the copolymer. Thus, the copolymers can be adapted to attract particular staining materials by including monomer units in the polymer chain which, inter alia, are ionically charged, or include polar moieties or unsaturated organic groups. Examples of such groups can include, for example, acid or amino groups, or salts thereof, or pendant alkenyl groups.

The non-polymeric particles may comprise particles of glass, silica, stone, or any of a variety of metals or ceramic materials. Suitable metals include, but are not limited to, zinc, titanium, chromium, manganese, iron, cobalt, nickel, copper, tungsten, aluminium, tin and lead, and alloys thereof. Suitable ceramics include, but are not limited to, alumina, zirconia, tungsten carbide, silicon carbide and silicon nitride.

The polymeric particles or non-polymeric particles may be of such a shape and size as to allow for good flowability and intimate contact with the substrate and particularly with textile fibre. A variety of shapes of particles may be used, such as cylindrical, ellipsoidal, spheroidal, spherical or cuboid. Appropriate cross-sectional shapes may be employed including, for example, annular ring, dog-bone and circular. Preferably, the particles comprise generally cylindrical, ellipsoidal or spherical beads. Ellipsoidal shaped particles are particularly preferred for cleaning methods as they provide good mechanical action on the substrate and are generally easier to separate from the substrate.

The polymeric particles or non-polymeric particles may have smooth or irregular surface structures and may be of solid, porous or hollow structure or construction.

The particles may have an average mass of from about 1 mg to about 1000 mg, of from about 1 mg to about 700 mg, of from about 1 mg to about 500 mg, of from about 1 mg to about 300 mg, of from about 1 mg to about 150 mg, of from about 1 mg to about 70 mg, of from about 1 mg to about 50 mg, of from about 1 mg to about 35 mg, of from about 10 mg to about 30 mg, of from about 12 mg to about 25 mg, of from about 10 mg to about 800 mg, of from about 50 mg to about 700 mg, or from about 70 mg to about 600 mg.

The polymeric or non-polymeric particles may have a surface area of from about 10 mm² to about 200 mm², of from about 10 mm² to about 120 mm², of from about 15 mm² to about 60 mm², of from about 20 mm² to about 40 mm², preferably from about 35 mm² to about 70 mm².

The polymeric particles may have an average density in the range of from about 0.5 to about 2.5 g/cm³, from about 0.55 to about 2.0 g/cm³, from about 0.6 to about 1.9 g/cm³, of from about 1.0 g/cm³ to about 1.8 g/cm³, preferably from about 1.4 to about 1.7 g/cm³.

The non-polymeric particles may have an average density greater than the polymeric particles. Thus, the non-polymeric particles may have an average density in the range of about 3.5 to about 12.0 g/cm³, from about 5.0 to about 10.0 g/cm³ or from about 6.0 to about 9.0 g/cm³.

The average volume of the polymeric and non-polymeric particles may be in the range of from about 5 to about 500 mm³, from about 5 to about 275 mm³, from about 8 to about 140 mm³, or from about 10 to about 120 mm³.

The solid particles may have an average particle diameter of from 1.0 mm to 10 mm, from 2.0 mm to 8.0 mm, or from 2.0 mm to 6.0 mm. The effective average diameter can also be calculated from the average volume of a particle by simply assuming the particle is a sphere. The average is preferably a number average. The average is preferably performed on at least 10, more preferably at least 100 particles and especially at least 1000 particles.

The solid particles may have a length of from 1.0 mm to 10 mm, of from 2.0 mm to 8.0 mm, or from 2.0 mm to 6.0 mm. The length can be defined as the maximum two-dimensional length of each three-dimensional solid particle. Preferably, the length is measured using Vernier calipers. The average is preferably a number average. The average is preferably performed on at least 10, more preferably at least 100 particles and especially at least 1000 particles.

Where the solid particles are cylindrical, they may be of oval cross section. The major cross section axis length, a, may be in the region of from 2.0 to 6.0 mm, of from 2.2 to 5.0 mm or of from 2.4 mm to 4.5 mm. The minor cross section axis length, b, may be in the region of from 1.3 to 5.0 mm, of from 1.5 to 4.0 mm, or of from 1.7 mm to 3.5 mm. For an oval cross section, a>b.

The length of the cylindrical particles, h, may be in the range of from about 1.5 mm to about 6 mm, from about 1.7 mm to about 5.0 mm, or from about 2.0 mm to about 4.5 mm. The ratio h/b may typically be in the range of from 0.5-10.

The cylindrical particles may be of circular cross section. The typical cross section diameter, d_{c}, can be in the region of from 1.3 to 6.0 mm, of from 1.5 to 5.0 mm, or of from 1.7 mm to 4.5 mm. The length of such particles, h_{c}, may be in the range of from about 1.5 mm to about 6 mm, from about 1.7 mm to about 5.0 mm, or from about 2.0 mm to about 4.5 mm. The ratio h_{c}/d_{c} may typically be in the range of from 0.5-10.

The particles may be generally spherical in shape (but not necessarily a perfect sphere) having a particle diameter, dₛ, in the region of from 2.0 to 8.0 mm, from 2.2 to 5.5 mm or from about 2.4 mm to about 5.0 mm.

The solid particles may be perfectly spherical in shape having a particle diameter, dₚₛ, in the region of from 2.0 to 8.0 mm, of from 3.0 to 7.0 mm, or from about 4.0 mm to about 6.5 mm.

As noted hereinabove, the dimensions of the solid particles are such that the apertures in the perforated portion of the separator should be smaller than the smallest dimension of the solid particles; the minimum distance between the outlet of the flow pathway pipe and the separator should be greater than the largest dimension of the solid particles.

The wash liquor may consist of water. Alternatively, at least one additional cleaning agent may be included in the wash liquor. The at least one cleaning agent may comprise at least one detergent composition. The at least one detergent composition may comprise cleaning components and post-cleaning components. The cleaning components may be selected from the group consisting of surfactants, enzymes and bleach. The post-treatment components may be selected from the group consisting of anti-redeposition additives, perfumes and optical brighteners.

The wash liquor may include at least one additive selected from the group consisting of builders, chelating agents, dye transfer inhibiting agents, dispersants, enzyme stabilizers, catalytic materials, bleach activators, polymeric dispersing agents, clay soil removal agents, suds suppressors, dyes, structure elasticizing agents, fabric softeners, starches, carriers, hydrotropes, processing aids and pigments.

Examples of suitable surfactants that can be included in the detergent composition can be selected from non-ionic and/or anionic and/or cationic surfactants and/or ampholytic and/or zwitterionic surfactants. The surfactant can typically be present at a level of from about 0.1%, from about 1%, or even from about 5% by weight of the cleaning compositions to about 99.9%, to about 80%, to about 35%, or even to about 30% by weight of the cleaning compositions.

The detergent composition may include one or more detergent enzymes which provide cleaning performance and/or fabric care benefits. Examples of suitable enzymes include, but are not limited to, hemicellulases, peroxidases, proteases, other cellulases, other xylanases, lipases, phospholipases, esterases, cutinases, pectinases, keratanases, reductases, oxidases, phenoloxidases, lipoxygenases, ligninases, pullulanases, tannases, pentosanases, malanases, [beta]-glucanases, arabinosidases, hyaluronidase, chondroitinase, laccase, and amylases, or mixtures thereof. A typical combination can comprise a mixture of enzymes such as protease, lipase, cutinase and/or cellulase in conjunction with amylase.

Optionally, enzyme stabilisers may also be included amongst the cleaning components. In this regard, enzymes for use in detergents may be stabilised by various techniques, for example by the incorporation of water-soluble sources of calcium and/or magnesium ions in the compositions.

The detergent composition may include one or more bleach compounds and optionally associated catalysts and/or activators. Examples of such bleach compounds include, but are not limited to, peroxygen compounds, including hydrogen peroxide, inorganic peroxy salts, such as perborate, percarbonate, perphosphate, persilicate, and mono persulphate salts (e.g. sodium perborate tetrahydrate and sodium percarbonate), and organic peroxy acids such as peracetic acid, monoperoxyphthalic acid, diperoxydodecanedioic acid, N,N′-terephthaloyl-di(6-aminoperoxycaproic acid), N,N′-phthaloylaminoperoxycaproic acid and amidoperoxyacid. Bleach activators include, but are not limited to, carboxylic acid esters such as tetraacetylethylenediamine and sodium nonanoyloxybenzene sulphonate.

Suitable builders may be included as additives and include, but are not limited to, the alkali metal, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

The additives may also optionally contain one or more copper, iron and/or manganese chelating agents and/or one or more dye transfer inhibiting agents.

The above components may be used either alone or in a desired combination and may be added at appropriate stages during the washing cycle in order to maximise their effects.

Water and the above components may be added into the drum by delivery means.

The composition of the wash liquor may depend at any given time on the point which has been reached in the cleaning cycle for the soiled substrate using the disclosed apparatus. For example, at the start of the cleaning cycle, the wash liquor may be water. At a later point in the cleaning cycle the wash liquor may include detergent and/or one of more of the above mentioned additives.

During a cleaning stage of the cleaning cycle, the wash liquor may include suspended soil removed from the substrate.

Typically, the wash liquor to substrate ratio is from about 5:1 to 0.1:1 w/w, from 2.5:1 to 0.1:1 w/w, or from 2.0:1 to 0.8:1 w/w in the drum. Particularly favourable results have been achieved at ratios such as 1.75:1 w/w, 1.5:1 w/w, 1.2:1 w/w and 1.1:1 w/w.

Conveniently, the required amount of water can be introduced into the drum of the apparatus according to the invention after loading of the soiled substrate into the drum.

The ratio of the multiplicity of solid particles to the substrate being cleaned is typically in the range of from about 0.1:1 to about 30:1 w/w, from about 0.1:1 to about 20:1 w/w, from about 0.1:1 to about 15:1 w/w, or from about 0.1:1 to about 10:1 w/w. The ratio of solid particles to substrate may be in the region of from about 0.5:1 to about 5:1 w/w, from about 1:1 to about 3:1 w/w, or around 2:1 w/w. Thus, for example, for the cleaning of 5 g of fabric, 10 g of polymeric or non-polymeric particles could be employed.

The ratio of solid particles to substrate may be maintained at a substantially constant level throughout the wash cycle. Consequently, pumping of fresh and recycled or recirculated solid particles can proceed at a rate sufficient to maintain approximately the same level of solid particles in the drum throughout the cleaning operation, thereby ensuring that the ratio of solid particles to soiled substrate stays substantially constant until the wash cycle has been completed.

The apparatus and the method of the present disclosure may be used for either small or large scale batchwise processes and finds application in both domestic and industrial, or commercial, cleaning processes.

The cleaning apparatus may be a domestic washing machine. Alternatively, the cleaning apparatus may be a commercial washing machine.

The cleaning apparatus of, and used in, the aspects of the disclosure described herein may be a commercial washing machine (sometimes referred to as a washer extractor). The drum may be of a size which is to be found in most commercially available washing machines and tumble driers, and may have a capacity in the region of 10 to 7000 litres. A typical capacity for a domestic washing machine would be in the region of 30 to 150 litres whilst, for an industrial washer extractor, capacities anywhere in the range of from 150 to 7000 litres are possible. A typical size in this range is that which is suitable for a 50 kg washload, wherein the drum has a volume of 450 to 650 litres and, in such cases, the drum would generally comprise a cylinder with a diameter in the region of 75 to 120 cm, preferably from 90 to 110 cm, and a length of from about 40 to about100 cm, preferably from about 60 to about 90 cm.

The cleaning apparatus of, and used in, the aspects of the disclosure described herein may be a domestic washing machine. Typically said domestic washing machine comprises a drum having a capacity of from 30 to 150 litres. The rotatably mounted drum may have a capacity of from 50 to 150 litres. Generally the drum of a domestic washing machine will be suitable for a 5 to 15 kg washload. Here the drum can typically comprise a cylinder with a diameter in the region of 40 to 60 cm and a length in the region of 25 cm to 60 cm. The drum may typically have 20 to 25 litres of volume per kg of washload to be cleaned.

Typically, the housing of the cleaning apparatus has a length dimension of from about 40 cm to about 120 cm, a width dimension of from about 40 cm to about 100 cm and a height of from about 70 cm to about 140 cm.

The housing of the cleaning apparatus may have a length dimension of from about 50 cm to about 70 cm, a width dimension of from about 50 cm to about 70 cm and a height of from about 75 cm to about 95 cm. In particular, the housing of the cleaning apparatus can have a length dimension of about 60 cm, a width dimension of about 60 cm and a height of about 85 cm. The cleaning apparatus may be comparable in size to a typical front-loading domestic washing machine commonly used in the Europe.

The housing of the cleaning apparatus may have a length dimension of from about 50 cm to about 100 cm, a width dimension of from about 40 cm to about 90 cm and a height of from about 70 cm to about 130 cm. In particular, the housing or cabinet can have a length dimension of from about 70 cm to about 90 cm, a width dimension of from about 50 cm to about 80 cm and a height of from about 85 cm to about 115 cm. More particularly, the housing of the cleaning apparatus may have a length dimension of from about 77.5 cm to about 82.5 cm, a width dimension of from about 70 cm to about 75 cm and a height of from about 95 cm to about 100 cm. More particularly, the housing of the cleaning apparatus may have a length dimension of about 71 cm (28 inches), a width dimension of about 80 cm (31.5 inches) and a height of about 96.5 cm (38 inches). The cleaning apparatus may be comparable in size to a typical front-loading domestic washing machine commonly used in the USA.

The cleaning apparatus is designed to operate in conjunction with soiled substrates and a multiplicity of solid particles. The multiplicity of solid particles may be efficiently circulated to promote effective cleaning and the cleaning apparatus, therefore, may include circulation means. Thus, the inner surface of the cylindrical side walls of the drum may comprise a multiplicity of spaced apart elongated protrusions affixed essentially perpendicularly to the inner surface. The protrusions may additionally comprise air amplifiers which are typically driven pneumatically and are adapted so as to promote circulation of a current of air within the drum. Typically the cleaning apparatus may comprise from 3 to 10, preferably 4, of the protrusions, which are commonly referred to as “lifters”.

The lifters may be adapted to collect solid particles and transfer them to a lower portion of the housing, such as to a sump. Lifters may comprise collecting and transferring means in the form of a plurality of compartments. The lifters may be located at equidistant intervals on the inner circumferential surface of the drum. The lifters may comprise a first aperture allowing ingress of the solid particles into a capturing compartment and a second aperture allowing transfer of the solid particles. The dimensions of the apertures may be selected in line with the dimensions of the solid particles, so as to allow efficient ingress and transfer thereof.

In operation, agitation is provided by rotation of the drum of the cleaning apparatus. However, there may also be additional agitating means, in order to facilitate the efficient removal of residual solid particles at the end of the cleaning operation. The agitating means may comprise an air jet, a water jet and/or a vibrating means.

In order to reduce the impact of vibrations being transmitted from the rotating drum to the housing, the cleaning apparatus may be hard-mounted or soft-mounted. In a hard-mounted arrangement, the housing of the apparatus is fixedly attached or tethered to the ground or floor or other solid object on which the apparatus is located. In a soft-mounted arrangement, instead of having the housing fixedly attached or tethered to the ground or solid object, the apparatus comprises dampers and/or springs to reduce the extent to which vibrations from the drum are transmitted to the housing.

The cleaning apparatus may comprise at least one delivery means. The delivery means can facilitate the entry of wash liquor constituents directly to the drum. In this way, the wash liquor constituents (such as water and/or detergents) may be added to the drum without needing to travel via the pumping means and, for example, via the sump. There may be a multiplicity of delivery means. Suitable delivery means can include one or more spraying means such as a spray nozzle. The delivery means may deliver water, one or more cleaning agents or water in combination with one or more cleaning agents. The delivery means may be adapted to first add water to moisten the soiled substrate before commencing the wash cycle. Alternatively or in addition, the delivery means may be adapted to add one or more cleaning agents during the wash cycle.

The cleaning apparatus may additionally comprise means for circulating air within the housing, and for adjusting the temperature and humidity in the cleaning apparatus. The means may include, for example, a recirculating fan, an air heater, a water atomiser and/or a steam generator. Additionally, sensing means may also be provided for determining the temperature and humidity levels within the cleaning apparatus and for communicating this information to control means which may be worked by an operative.

The disclosure is further illustrated by reference to the following drawings, wherein:

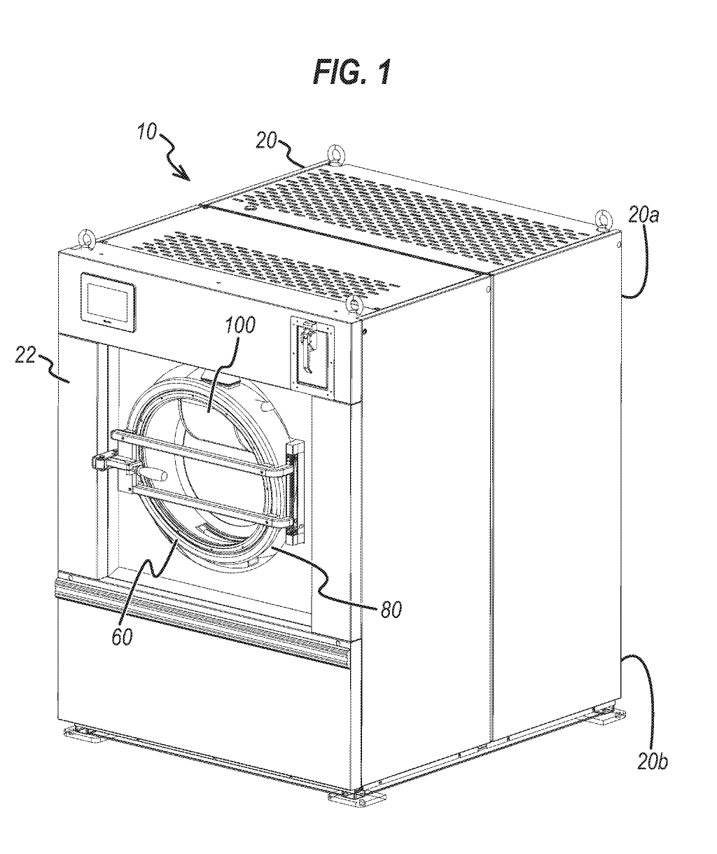

FIG. 1 shows an external perspective view of the cleaning apparatus according to the disclosure;

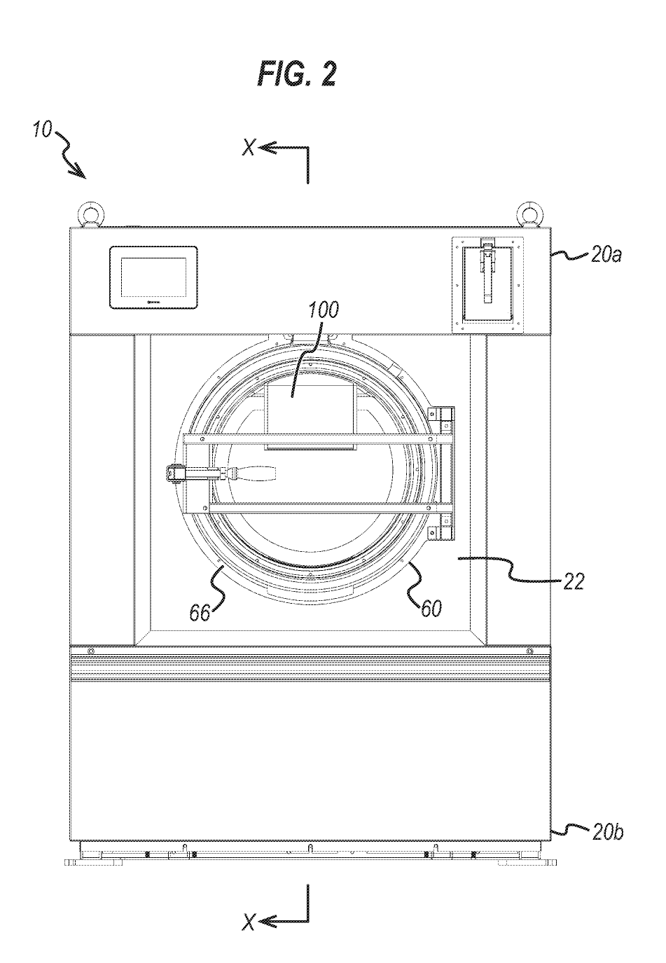

FIG. 2 shows a front view of the cleaning apparatus according to the disclosure;

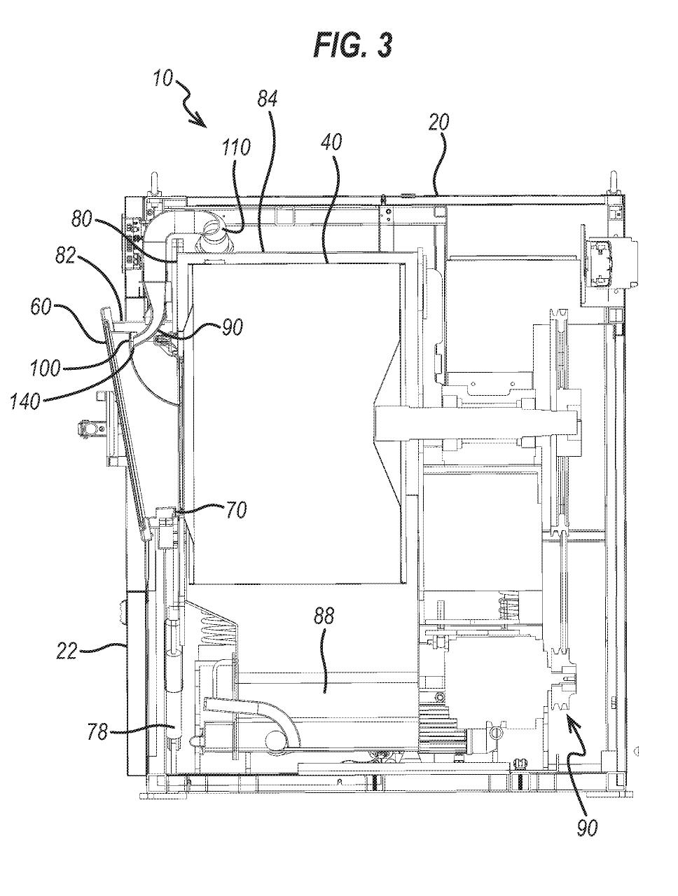

FIG. 3 shows a cross-sectional view of the cleaning apparatus through section X-X of FIG. 2;

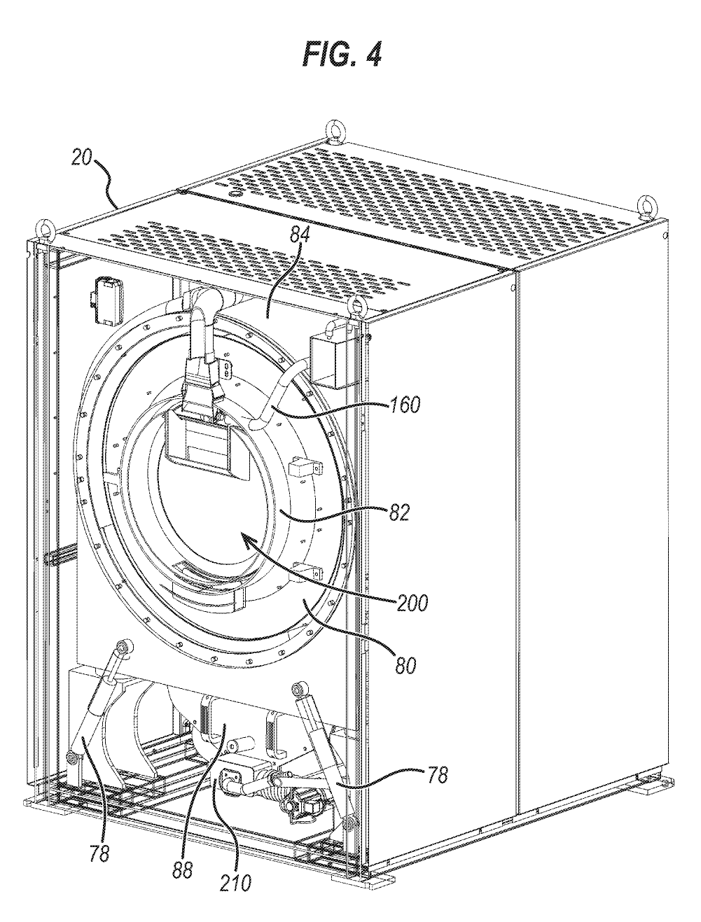

FIG. 4 shows a cut-away sectional perspective view of the cleaning apparatus with part of the front of the housing and part of the door removed;

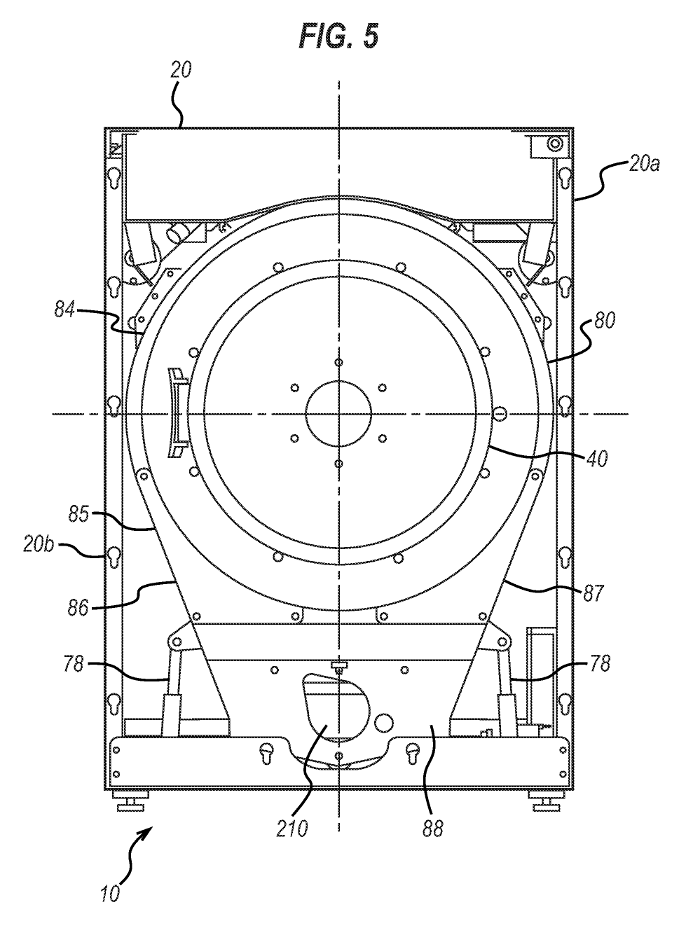

FIG. 5 shows a cross-sectional front view of the cleaning apparatus according to the disclosure; and

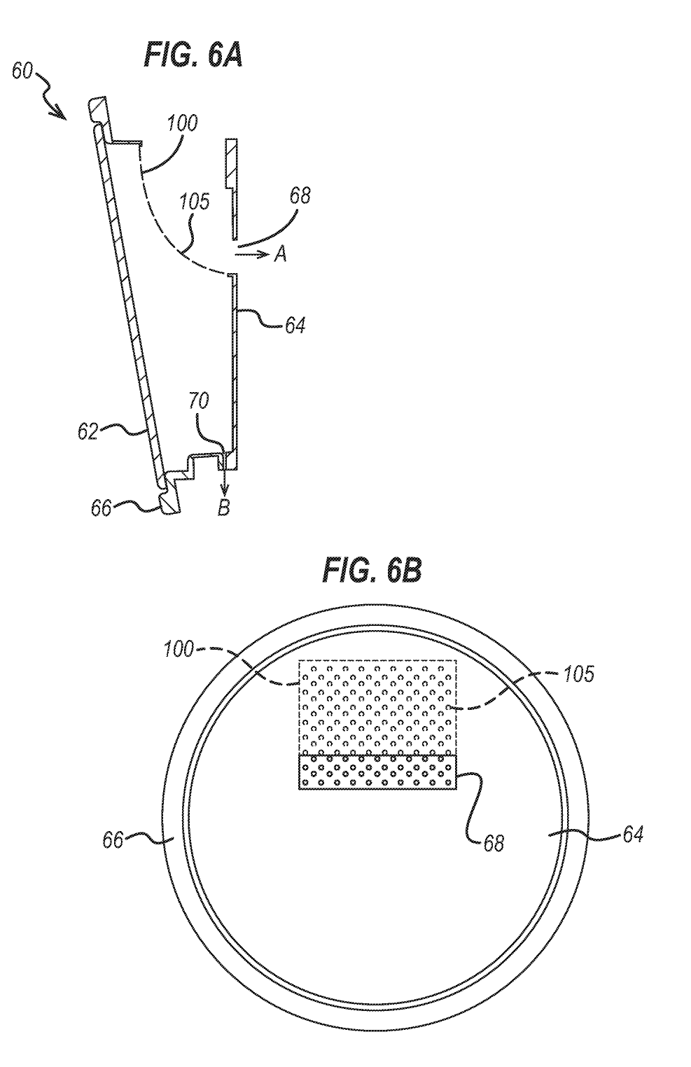

FIG. 6A shows a cross-section view of the door shown in FIG. 3;

FIG. 6B shows a rear view of the door; and

FIG. 7 shows a schematic diagram of the way that wash liquor and the multiplicity of particles strike and leave the separator.

With reference to FIGS. 1 to 5, there is provided a cleaning apparatus (10) according to an aspect of the present disclosure comprising a housing (20). The housing (20) comprises an upper portion (20a) and a lower portion (20b). The housing (20) comprises a rotatably mounted drum (40). The drum (40) may be in the form of a rotatably mounted cylindrical cage. The drum is horizontally mounted in a casing or a tub (80) and is mounted in the upper portion (20a) of the housing. The tub (80) comprises a curved top portion (84) that circumferentially surrounds a portion of the drum (40). The tub (80) comprises a first sidewall (85) and a second sidewall (87) extending from the curved portion (84) to the base of the tub (86).

The drum (40) has perforated side walls (not shown). The perforations allow the ingress and egress of fluids and the solid particles. Alternatively, the drum may have perforations that permit the ingress and egress of fluids and fine particulate materials of lesser diameter than the holes but are adapted so as to prevent the egress of the solid particles used to clean the soiled substrate.

Rotation of the drum (40) is effected by use of drive means (90). The drive means (90) comprises electrical drive means in the form of an electric motor. The operation of the drive means (90) is effected by control means which may be operated by a user.

The base (86) of the tub (80) includes a sump (88). The sump (88) functions as a chamber for retaining the solid particles. The sump (88) can further contain water and/or one or more cleaning agents. The sump (88) comprises heating means (not shown) allowing its contents to be raised to a preferred temperature for use in the cleaning operation.

The unitary nature of the tub (80) enables the portion containing the drum (40) and the portion comprising the sump (88) to move together as one body in response to vibrations induced by rotation of the drum (40). The cleaning apparatus (10) comprises dampers (78) connected to the tub (80) to reduce the extent to which vibrations from the drum are transmitted to the housing (20).

The cleaning apparatus has a collar or hood (82) that projects out from the front face (22) of the housing (20) around part or all of the opening (200) of the housing through which the drum (40) is accessible. The collar or hood (82) may extend from or be an integral part of the tub (80).

The collar or hood (82) comprises an aperture (90). The apparatus has a flow pathway pipe (110) having an outlet (140) that defines a path between the sump (88) and a separator (100). The flow pathway pipe is configured so that it is mounted in the housing and passes through the aperture (90) of the collar or hood (82).

A pump (210) is arranged so that it is able to pump wash liquor and solid particles from the sump (88), along the flow pathway pipe (110) and onto the separator (100).

The apparatus comprises delivery means (160) through which wash liquor constituents (such as water and/or detergents) may be added to the drum without needing to travel via the flow pathway pipe (110).

The cleaning apparatus (10) comprises a door (60) to allow access to the interior of the drum (40). The door (60) is hingedly coupled or mounted to the front (22) of the housing (20). In an alternative arrangement (not shown) the door (60) may be hingedly coupled or mounted to a portion of the tub (80).

The door is moveable between an open and a closed position. When the door (60) is in a closed position (as shown in FIGS. 1, 2 and 3), the cleaning apparatus (10) is substantially sealed. When the door (60) is in an open position, the inside of the drum (40) is accessible. In the arrangement shown, when the door is in the closed position, the door abuts and makes a seal with the collar (82).

The door (60) comprises a separator (100). The separator comprises a perforated portion (105) and is adapted to receive wash liquor and a multiplicity of solid particles from the outlet (140) of the flow pathway pipe (110).

Referring in particular to FIGS. 6A and 6B, the door (60) comprises a ring (66). The door has an outer portion (62) and an inner portion (64). The outer portion (62) and the inner portion (64) are mounted in the ring (66). The outer portion (62) and the inner portion (64) of the door (60) may be transparent material, such as glass, which facilitates viewing of the inside of the drum during operation of the machine.

The door comprises a separator (100). In the arrangement shown in FIGS. 6A and 6B, the separator (100) is curved and is mounted between the outer portion (62) and the inner portion (64) of the door. The ring (66) is adapted to hold the separator (100) in position between the outer portion (62) and the inner portion (64) of the door (60).

The inner portion (64) of the door (60) comprises a door outlet (68). Material from the wash liquor/solid particle mixture that does not pass through the separator (100), travels down the slope of the separator (100) and through the door outlet (68), in the direction shown by the arrow A, and is able to pass into the drum. Having a door arranged with an inner portion reduces there being any snagging of the soiled substrate being cleaned on the separator (100) but requires the door outlet (68) in order for the solid particles to enter the drum (40).

The ring (66) of the door comprises a drain channel (70) located at the bottom of the door (60). The channel (70) is arranged such that material that has passed through the separator, such as wash liquor, is able to exit the door through the drain channel (70) in the direction shown by the arrow B and flows into the sump (88).

Referring to FIG. 7, preferably, the flow pathway pipe (110) is oriented so that the wash liquor and multiplicity of solid particles leaves the outlet (140) at an angle θ from horizontal. On striking the perforated portion of the curved separator (100), the wash liquor passing through the perforated portion travels down in direction D. The multiplicity of solid particles travel down along the curve of the separator in direction E. As the solid particles travel down along the curve of the separator, more wash liquor passes through the perforated portion in direction D. At the end of the separator, the solid particles are directed in a path F towards the drum. The angle ϕ is the angle above horizontal taken at a tangent at the end of the trailing edge of the curved separator. Preferably, angle θ is about 15° to 35°, more preferably about 20° to 30°. Preferably, angle ϕ is about 0° to 35°, preferably about 0° to 30°, preferably about 5° to 25°, preferably about 10° to 20°. Preferably, angle ϕ is about 15° to 35°, more preferably about 20° to 30°.

In use, wash liquor combined with a multiplicity of solid particles is transported from the sump (88) to the separator (100) using the pump (210). The wash liquor and the solid particulate material are pumped along the flow pathway pipe (110) and out through the outlet (140) onto the perforated portion (105) of the separator (100). Wash liquor is permitted to pass through the perforated portion (105) of the separator. However, as the solid particles are too large to exit via the apertures in the perforated portion, the solid particles are deflected by the surface of the separator (100) towards the door outlet (68). In this manner, separation of at least a portion of the wash liquor from the multiplicity of solid particles can be achieved.

In a typical wash cycle using the cleaning apparatus (10), soiled substrates (not shown) are first placed into the drum (40). An appropriate amount of wash liquor (water, together with any additional cleaning agent) is then added to the drum (40) via the delivery means (160). The water may be pre-mixed with the cleaning agent prior to its introduction into the drum (40). However, typically, water is added first in order to suitably wet or moisten the substrate before further introducing any cleaning agent.

The water and the cleaning agent may be heated by a heater (not shown). Following the introduction of water and any optional cleaning agents, the wash cycle commences by rotation of the drum (40). The solid particles and wash liquor residing in the sump (88), which optionally can be heated to a desired temperature using a heater (not shown), are then pumped via the flow pathway pipe (140) to the separator (100) in the door (60). Solid particles are propelled from the separator (100) through the door outlet (68) and into the centre of the washload in the drum (40).

During the course of agitation by rotation of the drum (40), water including any cleaning agents falls through the perforations in the drum (40) and into the sump (88). Some solid particles may also fall through perforations in the drum (40) and into the sump (88). Lifters (not shown) disposed on the inner circumferential surface of the drum (40) can collect the solid particles as the drum (40) rotates and transfer the solid particles to the sump (88). On transfer to the sump (88), the solid particles and water plus any cleaning agents travel down the sloping walls (85) and (87) of the tub to the base of the sump (88). The pump (210) again pumps wash liquor in combination with the solid particles upwardly via the flow pathway pipe (110) and to the separator (100) in the door (60). Consequently, additional solid particles can be entered into the drum (40) during the wash cycle. Furthermore, solid particles used in the cleaning operation and returned to the sump (88) can be reintroduced into the drum (40) and can therefore be re-used in either a single wash cycle or subsequent wash cycles. Wash liquor pumped from the sump (88) through the separatior (100) with the solid particles which does not enter the drum (40) can be returned to the sump (88) via the drain (70) in the door (60).

The cleaning apparatus (10) can perform a wash cycle in a manner similar to a standard washing machine, for example, with the drum (40) rotating at from about 30 to about 40 rpm for several revolutions in one direction, then rotating a similar number of rotations in the opposite direction.

This sequence can be repeated for up to about 60 minutes. During this period, solid particles can be introduced and reintroduced to the drum (40) from the sump (88) via the separator (100) in the manner as described above.

The conditions employed in the use of the cleaning apparatus allow for significantly reduced temperatures from those which typically apply to the conventional wet cleaning of textile fabrics and, as a consequence, offer significant environmental and economic benefits. Typical procedures and conditions for wash cycles require that fabrics are generally treated according to the disclosed method at, for example, temperatures of from about 5 to about 95° C. for a duration of from about 5 to about 120 minutes in a substantially sealed system. Thereafter, additional time may be required for the completion of the rinsing and any further stages of the overall process. The total duration of the entire cycle is typically in the region of about 1 hour. The operating temperatures for the method of the invention are preferably in the range of from about 10 to about 60° C., or from about 15 to about 40° C.

Features described herein in conjunction with a particular aspect or example of the disclosure are to be understood to be applicable to any other aspect, embodiment or example described herein unless incompatible therewith. As used herein, the words “a” or “an” are not limited to the singular but are understood to include a plurality, unless the context requires otherwise.

### EXAMPLES

### Example 1

A cleaning apparatus according to the disclosure was used in which a separator was located in the door. The separator was curved. The direction of curvature of the separator was such that solid particles following the direction of the curve were led towards the drum. The cleaning apparatus was of a size suitable for washing 35 lb (15.9 kg) of substrate. A 1:1 by weight mixture of wash liquor and polymeric beads was pumped from the sump towards the separator. The beads were ellipsoid shaped having a longest dimension of about 4 mm. The cross-sectional area of the flow pathway pipe at the pump was 3168 mm², which reduced along its length to 2028 mm². The cross-sectional area of the outlet was 2033 mm². The cross-section of the flow pathway pipe was circular and the outlet had an elongate shape. The beads that had passed through the separator into the drum were collected and bead wetness was assessed by capturing the solid particles directed to the drum by the separator, weighing them and then separating off the remaining water in the solid particles, as described herein. The bead wetness was 12.7 wt %.

### Example 2

Example 1 was repeated but the cross-sectional area of the outlet was reduced to 1869 mm². The outlet remained in an elongate shape. The bead wetness of the beads collected from the drum was 10.3 wt %. Thus, reducing the cross-sectional area of the outlet leads to improved bead and wash liquor separation, resulting in drier beads being directed to the drum.

### Example 3

A cleaning apparatus according to the disclosure was used in which a separator was located in the door. The separator was curved. The direction of curvature of the separator was such that solid particles following the direction of the curve were led towards the drum. The cleaning apparatus was of a size suitable for washing 35 lb (15.9 kg) of substrate. A 1:1 by weight mixture of wash liquor and polymeric beads was pumped from the sump towards the separator. The beads were ellipsoid shaped having a longest dimension of about 4 mm. The cross-sectional area of the flow pathway pipe at the pump was 3168 mm², which reduced along its length to 2028 mm². The cross-sectional area of the outlet was 2033 mm². The cross-section of the flow pathway pipe was circular and the outlet had an elongate shape. The velocity of the beads and the wash liquor at the point of exiting the outlet was measured and was found to be 250.4 cm/s.

### Example 4

Example 3 was repeated but the cross-sectional area of the outlet was reduced to 1869 mm². The outlet remained in an elongate shape. The velocity of the beads and the wash liquor at the point of exiting the outlet was measured and was found to be 272.4 cm/s.

### Example 5

A cleaning apparatus according to the disclosure was used in which a separator was located in the door. The separator was curved. The direction of curvature of the separator was such that solid particles following the direction of the curve were led towards the drum. The cleaning apparatus was of a size suitable for washing 35 lb (15.9 kg) of substrate. A 1:1 by weight mixture of wash liquor and polymeric beads was pumped from the sump towards the separator at a pumping speed of 38 Hz. The beads were ellipsoid shaped having a longest dimension of about 4 mm. The cross-section of the flow pathway pipe was circular. The cross section of the outlet was circular and was cut normal to the pipe. The beads that had passed through the separator into the drum were collected and bead wetness was assessed. The results of the bead wetness are shown in Table 1.

### Example 6

Example 5 was repeated but at a pumping speed of 50 Hz. The results of the bead wetness are shown in Table 1.

### Example 7

Example 5 was repeated but the outlet was shaped so that each point on the perimeter of the outlet was equidistant from the perforated portion of the separator. The pumping speed was 35 Hz. The beads that had passed through the separator into the drum were collected and bead wetness was assessed. The results of the bead wetness are shown in Table 1.

### Example 8

Example 7 was repeated but at a pumping speed of 50 Hz. The results of the bead wetness are shown in Table 1.

TABLE 1

| | Example 5 | Example 6 | Example 7 | Example 8 |
|---|---|---|---|---|
| Distance | Not equidistant | Not equidistant | Equidistant | Equidistant |
| of outlet | | | | |
| perimeter | | | | |
| from | | | | |
| separator | | | | |
| Pumping | 38 | 50 | 35 | 50 |
| speed | | | | |
| (Hz) | | | | |
| Bead | 28.5 | 22 | 16.2 | 14.75 |
| wetness | | | | |
| wt % | | | | |

Examples 9 to 17

A cleaning apparatus according to the disclosure was used in which a separator was located in the door. The separator was curved. The direction of curvature of the separator was such that solid particles following the direction of the curve were led towards the drum. The cleaning apparatus was of a size suitable for washing 35 lb (15.9 kg) of substrate. A 1:1 by weight mixture of wash liquor and polymeric beads was pumped from the sump towards the separator at different distances between the perimeter of the outlet and the separator, and different relative orientations of the flow pathway pipe outlet and curved separator. The beads were ellipsoid shaped having a longest dimension of about 4 mm. In each case, the flow pathway pipe was circular and the end face of the outlet was circular. The outlets were either straight cut, thereby having a circular perimeter, or else were shaped to correspond to the curvature of the separator. In each case, the beads that had passed through the separator into the drum were collected and bead wetness was assessed by capturing the solid particles directed to the drum by the separator, weighing them and then separating off the remaining water in the solid particles, as described herein. The results are shown in Table 2. As shown in FIG. 7, angle θ is the angle below horizontal that the wash liquor and multiplicity of solid particles leave the outlet. The angle ϕ is the angle above horizontal taken at a tangent at the end of the trailing edge of the curved separator.

TABLE 2

| | | | | | Distance of | Arrangement | |
|---|---|---|---|---|---|---|---|
| | | | Pumping | Outlet | perimeter of | of perimeter | Bead |
| | | | speed | shaped or | outlet from | of outlet to | wetness |
| Example | θ (°) | φ (°) | (Hz) | straight cut | separator (mm) | separator | (wt %) |
| 9 | 20 | 20 | 35 | Straight cut | 0 at top edge; | Not | 28.5 |
| | | | | | 9.6 at lower | equidistant | |
| | | | | | edge | | |
| 10 | 20 | 20 | 35 | Straight cut | 0 at top edge; | Not | 28.0 |
| | | | | | 9.6 at lower | equidistant | |
| | | | | | edge | | |
| 11 | 20 | 20 | 40 | Straight cut | 0 at top edge; | Not | 24.0 |
| | | | | | 9.6 at lower | equidistant | |
| | | | | | edge | | |
| 12 | 20 | 30 | 40 | Straight cut | 0 at top edge; | Not | 24.0 |
| | | | | | 9.6 at lower | equidistant | |
| | | | | | edge | | |
| 13 | 30 | 20 | 50 | Straight cut | 0 at top edge; | Not | 20.0 |
| | | | | | 18.7 at lower | equidistant | |
| | | | | | edge | | |
| 14 | 30 | 20 | 40 | Shaped | 6 | Equidistant | 18.0 |
| 15 | 30 | 20 | 50 | Shaped | 6 | Equidistant | 16.5 |
| 16 | 30 | 20 | 50 | Shaped | 6 | Equidistant | 16.5 |
| 17 | 20 | 30 | 50 | Shaped | 12 | Equidistant | 23.0 |

Examples 9 to 17 illustrate that having all points on the perimeter of the outlet equidistant from the separator improves bead wetness reduction. Also, reducing the gap between the outlet and the separator advantageously reduces bead wetness.

1. An apparatus for use in the treatment of at least one substrate with a multiplicity of solid particles comprising:
a) a housing in which a drum is rotatably mounted;
b) a door moveable between an open position wherein the at least one substrate can be placed in the drum and a closed position wherein the apparatus is substantially sealed;
c) a separator mounted in the door, wherein the separator comprises a perforated portion;
d) a flow pathway pipe mounted on or in the housing, wherein the flow pathway pipe comprises an outlet; and
e) pumping means configured to pump treatment liquor and a multiplicity of solid particles from a first location through the flow pathway pipe and out of the outlet towards the separator;
wherein the separator is arranged to direct the multiplicity of solid particles into the drum and wherein the separator is further arranged to direct a portion of the treatment liquor to a location other than the drum; and
wherein the flow pathway pipe is not attached to the door.

2. The apparatus of claim 1 wherein the cross-sectional area of the outlet is smaller than the cross-sectional area of the flow pathway pipe.

3. The apparatus of claim 2, wherein the cross-sectional area of the outlet is from about 10 to about 99% of the cross-sectional area of the flow pathway pipe.

4. The apparatus of claim 1 or claim 2, wherein the perimeter of the outlet is located no more than about 12 mm from the perforated portion of the separator, preferably no more than about 10 mm from the perforated portion of the separator.

5. The apparatus of any of the preceding claims, wherein the perimeter of the outlet is essentially equidistant from the perforated portion of the separator.

6. The apparatus of any of the preceding claims, wherein the outlet has an elongate shape, preferably the elongate shape has a length, L, and a width, W, such that the ratio L:W of the elongate shape is greater than 2:1.

7. The apparatus of any of the preceding claims, wherein the velocity of the treatment liquor and the solid particles at the outlet is about 150 cm/s or more.

8. An apparatus for use in the treatment of at least one substrate with a multiplicity of solid particles comprising:
(a) a housing in which a drum is rotatably mounted;
(b) a door moveable between an open position wherein the at least one substrate can be placed in the drum and a closed position wherein the apparatus is substantially sealed;
(c) a separator, wherein the separator comprises a perforated portion;
(d) a flow pathway pipe mounted on or in the housing, wherein the flow pathway pipe comprises an outlet; and
(e) pumping means configured to pump treatment liquor and a multiplicity of solid particles from a first location through a flow pathway pipe and out of the outlet towards the separator;
wherein the separator is arranged to direct the multiplicity of solid particles into the drum and wherein the separator is further arranged to direct a portion of the treatment liquor to a location other than the drum; and
wherein at least one of the following conditions is fulfilled:
(i) the cross-sectional area of the outlet is smaller than the cross-sectional area of the flow pathway pipe;
(ii) the outlet has an elongate shape;
(iii) the perimeter of the outlet is located no more than 30 mm, preferably no more than 12 mm from the perforated portion of the separator;
(iv) the perimeter of the outlet is essentially equidistant from the perforated portion of the separator;
(v) the velocity of the treatment liquor and the solid particles at the outlet is about 150 cm/s or more.

9. The apparatus of claim 8 wherein in condition (iii) the perimeter of the outlet is located no more than 12 mm from the perforated portion of the separator.

10. The apparatus of claim 8 or claim 9 wherein all of conditions (i) to (v) are fulfilled.

11. The apparatus of any of claims 8 to 10, wherein the cross-sectional area of the outlet is from about 10 to about 99% of the cross-sectional area of the flow pathway pipe.

12. The apparatus of any of claims 8 to 11 wherein the perimeter of the outlet is located no more than about 10 mm from the perforated portion of the separator.

13. The apparatus of any of claims 8 to 12, wherein the elongate shape has a length, L, and a width, W, such that the ratio L:W of the elongate shape is greater than 2:1.

14. The apparatus of any of claims 8 to 13, wherein the separator is located in the door.

15. The apparatus of claim 14, wherein the flow pathway pipe is not attached to the door.

16. The apparatus of any of claims 8 to 13, wherein the separator is mounted in a location other than in the door.

17. The apparatus of any of the preceding claims, wherein the outlet is configured such that the path of the treatment liquor and multiplicity of solid particles leaving the outlet defines an angle of incidence, λ, on the surface of the perforated portion of the separator of from about 60° to about 150°, preferably of from about 60° to about 120°.

18. The apparatus of any of the preceding claims, wherein the perforated portion of the separator is curved.

19. The apparatus of any of the preceding claims, wherein the wetness of the solid particles directed by the separator towards the drum is 20 wt % or less, preferably 15 wt % or less, preferably 10 wt % or less.

20. The apparatus of any preceding claim, wherein said location other than the drum is said first location, preferably wherein said first location is a sump.

21. The apparatus of any preceding claim wherein the bore of the flow pathway pipe narrows as the flow pathway pipe approaches its outlet, and preferably wherein the flow pathway pipe comprises a main portion and a nozzle portion and said narrowing of the bore of the flow pathway pipe occurs in the nozzle portion thereof preferably such that the cross-sectional area of the main portion is substantially constant along its length.

22. The apparatus of any of the preceding claims, wherein the apparatus is a cleaning apparatus for use in the cleaning of at least one soiled substrate, wherein said treatment liquor is a wash liquor.

23. The apparatus of any of claims 1 to 21, wherein the apparatus is an apparatus for treating a substrate with a multiplicity of solid particles, wherein the substrate is an animal substrate selected from skins, hides, pelts, leather and fleeces, preferably wherein treating is colouring, tanning and associated tanning processes.

24. A method of treating at least one substrate comprising the treatment of the substrate with a multiplicity of solid particles using the apparatus of any of claims 1 to 23.

25. The method of claim 24 comprising the steps of:
(a) loading the at least one substrate into the drum and closing the door;
(b) introducing treatment liquor to moisten the substrate;
(c) rotating the drum;
(d) operating pumping means to pump treatment liquor and the multiplicity of solid particles from the first location through the flow pathway pipe towards the separator and introducing the multiplicity of solid particles into the drum via the separator.

26. The method of claim 25, further comprising the step of:
(e) operating the apparatus for a treatment cycle wherein the treatment liquor and the multiplicity of solid particles are transferred from the drum into a lower portion of the housing as the drum rotates.

27. The method of claim 26, further comprising the steps of:
(f) operating the pumping means so as to pump additional treatment liquor and solid particles from the first location to the separator and to recirculate the multiplicity of solid particles used in step (d) for re-use in the treatment operation; and
(g) continuing with steps (c), (d), (e) and (f) as required to effect treatment of the at least one substrate.

28. The method of any of claims 24 to 27, wherein the method of treating is a method of cleaning at least one soiled substrate and wherein the treatment liquor is a wash liquor.

29. The method of any of claims 24 to 28, wherein the method of treating is a method of treating a substrate with a multiplicity of solid particles, wherein the substrate is an animal substrate selected from skins, hides, pelts, leather and fleeces, preferably wherein treating is colouring, tanning and associated tanning processes.
